(19) United States
(12) Patent Application Publication
(10) Pub. No.: US 2021/0161085 A1
(43) Pub. Date: Jun. 3, 2021

(54) SAW TEETH MOUNTED RADIALLY BY SCREWED JOINT ON SAW DISKS, USED IN FELLER-BUNCHER HEADERS, COUPLED TO FOREST TRACTORS

(71) Applicant: Werner Kruger D'Almeida, Curitiba (BR)

(72) Inventor: Werner Kruger D'Almeida, Curitiba (BR)

(21) Appl. No.: 16/912,739

(22) Filed: Jun. 26, 2020

(30) Foreign Application Priority Data
Nov. 29, 2019 (BR) 20 2019 025354 7

(51) Int. Cl. A01G 23/081

(52) U.S. Cl. CPC A01G 23/081

(57) ABSTRACT

Improvements made in the configuration of the metal tooth with cutting blades for forest wood. The present patent application is related to the mechanical engineering field; in the forest cutting segment. configuration applied to a metal tooth (1), of sharp cutting edges (2) in its upper structures, formed of a fine concave ring layer (3) made by welding of a composition of tungsten carbide and cobalt, extremely abrasion-resistant; provided with wearing face surface (4), made of carbon steel of low abrasion resistance, proper of the support body, teeth, which wear more intensively when in contact with the soil and the wood, providing maintenance, formation of sharp edge, always cutting.

### CROSS REFERENCE TO RELATED APPLICATION

This application claims priority to and takes the benefit of Brazil Patent Application No. BR 20 2019 025354 7, filed on Nov. 29, 2019, the contents of which are herein incorporated by reference.

The present application for patent of a utility model is related to improvements made in the configuration of the metal saw teeth mounted radially by screwed joint on a saw disk, used in feller-buncher headers coupled to forest tractors.

### FIELD OF APPLICATION

The present application for patent of a utility model is related to the mechanical engineering field; in the forest cutting segment.

### STATE OF ART

The main functions of the forest tractors used for cutting planted trees are: to assure total safety of the workers, as they are totally sheltered in reinforced cabins, saving their lives, when compared to the manual cutting work by means of chainsaw; to enable high production, when compared to the manual activity; to promote reduction in the production cost.

The activity started recently, enabling to understand the high global demand for raw material derivatives (wood) obtained from forests, planted trees, reforesting.

Regarding the feller header models, there are two models: A—header, where cutting is done by a bar and chain of the chainsaw type, called Harvester, and B—header, where cutting is done by a circular saw of big dimensions placed horizontally called Feller Buncher. Header “A” is used when precision and selection when cutting the tree are necessary, enabling its complete processing in the forest by means of removal of branches with precise cuts, selected by diameter x length by an on-board computer. Header model “B” is more rustic, not enabling selection of the cut by diameter x length. It has been created for total felling of the planted area, said plain cut. The differential of this model is the high production that can be achieved, about 6 times higher when compared to header “A”. Model “A” is used for thicker trees of higher value added, while model “B” is used for cutting thinner trees, where lower operational cost is required. Model “B” cuts the tree dynamically, considering that it is not necessary to stop, and it accumulates the cut trees, depositing them in a oriented way to enable their removal by another drag tractor to the road bank, where they are processed in pieces by grapple saws or processing headers Harvester.

Description of the Art and Proposed Solution

The present application of utility model refers to model “B”, more specifically in the configuration of screwed cutting tool called sawtooth. In the current market, there are different models of sawteeth, considering two main ones: A—Sawtooth with hard metal pad inserts with cutting edges on their cutting surface; B—Thermally hardened teeth, without hard metal pad insert.

Sawteeth “A” with hard metal pad insert show extraordinary resistant to wear, and their service life is up to 10 times higher when compared to tooth “B”.

On its turn, tooth “B” is deployed in lands, where there are high risks of shock with solid debris, such as stones, as its acquisition cost is 40% lower than “A”.

Today, there is an open gap for an intermediary product on the market, for the acquisition cost, for the need of longer durability than the hardened tooth and energetic efficiency because of the characteristics due to the maintenance of the cutting-edge land of width.

The tooth model, the protection of which is claimed by means of the referred utility model patent application, shows an extraordinary advantage in the maintenance of the cutting edges because of the fact that they are self-sharpening. This self-sharpening characteristics is achieved by the fact that there is a fine surface layer hot-deposited in the central concavity of the tooth, which borders the cutting edges, composed of solid pieces of hard metal, crushed into fine granules, welded by cobalt alloys, highly abrasion-resistant, where the tooth sides, made of carbon steel without heat treatment, are those to wear out due to the natural friction suffered in the cutting process, forming an exposed dentin with sharp and cutting edge. In addition to providing higher quality, less fibrous cutting necessary to cut eucalyptus for re-growth, maintenance of the sharp cutting edges enables reduction of the cutting energy, benefiting nature by the reduction of the emission of carbon released into the atmosphere, because the forest tractor are moved by fossil fuel.

For better comprehension of the current art used for cutting trees in movement, of the feller buncher tractors, it is necessary to know that the high instantaneous cutting energy in this kind of equipment comes from the inertial kinetic energy accumulated in the disk mass, which also works as inertial stirring wheel made of solid carbon steel, highly resistant, which works under controlled rotation. The controlled rotation of the saw disk becomes necessary in order to keep the accumulated energy sufficient to cut the log through, without any risk to stop in the middle of the log cutting. Stop in the middle of the cutting leads to high loss because the disk might be warped, it is a high-value piece, which has to be replaced. For this undesired effect not to occur, there is a minimum rotation control system viewed by an instruments called tachometer, controlled by the operator, so, whenever the disk reaches a minimum value of necessary energy, the tractor is stopped to replace the energy by increasing the disk rotation, raising its maximum inertial energy build-up. Such factors are necessary for complete comprehension of the big benefit achieved whether by the improvement in the energetic efficiency, the increase in productivity, the savings in maintenance and the lower risks of damages to the equipment, achieved by means of this precious improvement, because a tooth, which is always sharp, reduces the energy consumed per cut tree drastically, providing higher productivity for keeping the cutting edge of the tooth always sharp, on the contrary to other models of teeth, the cutting edges of which get rounded upon natural wear in the process, spending more energy per cut tree.

There is deployment of all teeth to serve given lands. The teeth in the market wear quickly because of the high energy generating during the cutting. The present utility model application presents a proposal of a configuration of a metal tooth with cutting blade, where said metal tooth presents self-sharpening function, providing a cutting knife (edge) always, promoting less energy at the time of cutting.

The proposal of a new configuration of the metal tooth with cutting blade is a version, which presents reduction of the production costs: reduction of the part acquisition cost; reduction of the energy spent by the machine, reduction of the part wear, reduction of the operational cost, once the cutting edges are available for cutting for a long time, reducing the consumption of fuel and wear of the machine components. Furthermore, less loss of disk rotation; thus, it promotes cutting increase, increasing the production.

With the purpose to sole the existing problems in the state of art, after several studies and tests, the applicant developed the “IMPROVEMENT OF SAW TEETH MOUNTED RADIALLY BY SCREWED JOINT ON SAW DISKS, USED IN FELLER-BUNCHER HEADERS, COUPLED TO FOREST TRACTORS”. The purpose of this new constructive version is to serve the market with an intermediary version between hardened teeth and teeth with hard metal pad inserts. The differentiated and main proposal of the improvement of the metal tooth with cutting blade (in relation to the current art) is to create a metal tooth with self-sharpening feature, once tungsten carbide is in the inner part of the tooth construction and the part wear occurs on the outer part, that is, providing a cutting edge (knife) always. With the cutting edge, less cutting energy is used in the wood cutting process.

The metal tooth with cutting blade proposed in this utility model application is composed of an inner layer of tungsten carbide in small pieces alloyed with cobalt, that is, carbide pad welded in small pieces on the inner part layer.

The following are highlighted as benefits: lower acquisition cost and always cutting tip. Its durability in sandy lands is not the same as teeth with tungsten carbide only. The metal tooth proposed in the present utility model serves customers, who want to cut in higher lands, maintaining the cutting edge, the cut will be more perfect.

### DETAILED DESCRIPTION OF THE FIGURES

For better comprehension of a preferred deployment of the utility model application proposed herein, the following figure is presented for illustration:

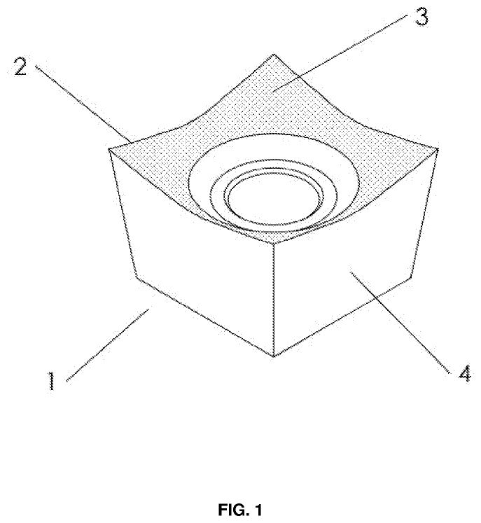

FIG. 1 represents a perspective view of the configuration applied to a metal tooth (1) of sharp cutting edges; (2) in its upper structures, formed of a fine concave ring layer (3) made by welding of a composition of tungsten carbide and cobalt, extremely abrasion-resistant; provided with wearing face surface; (4) made of carbon steel of low abrasion resistance, proper of the support body, teeth, which wear more intensively when in contact with the soil and the wood, providing maintenance, formation of sharp edge, always cutting.

What is claimed is:

1) “IMPROVEMENT OF SAW TEETH MOUNTED RADIALLY BY SCREWED JOINT ON SAW DISKS, USED IN FELLER-BUNCHER HEADERS, COUPLED TO FOREST TRACTORS”, characterized for presenting a configuration applied to a metal tooth (1) of sharp cutting edges; (2) in its upper structures, formed of a fine concave ring layer; (3) made by welding of a composition of tungsten carbide and cobalt, extremely abrasion-resistant; provided with wearing face surface; (4) made of carbon steel of low abrasion resistance, proper of the support body, teeth, which wear more intensively when in contact with the soil and the wood, providing maintenance, formation of sharp edge, always cutting.
